(19) United States
(12) Patent Application Publication
(10) Pub. No.: US 2009/0006449 A1
(43) Pub. Date: Jan. 1, 2009

(54) Modeling and Analysis of Computer Networks

(75) Inventors: Stewart P. MacLeod, Woodenville, WA (US); Felix W. Wong, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/771,056

(22) Filed: Jun. 29, 2007

(51) Int. Cl. G06F 7/00

(52) U.S. Cl. 707/102; 707/E17.044

(57) ABSTRACT

A computer network may be modeled using a declarative definition that includes classes and relationships between classes. A discovery tool may populate a database with instances of the classes and enable an analysis tool to apply a constraint model so that a subset of possible alternatives may be defined. In some cases, further analysis may be performed on items contained in the subset.

### BACKGROUND

Large enterprises or businesses may have many computers attached to a network. In some cases, a network may be a complex wide area network with several servers, routers, and many individual computers. Each device may have many different characteristics, including hardware and software characteristics.

When a new deployment of software or hardware is being considered, an information technologies professional may wish to determine the best implementation. For example, upgrades of server services, the addition of a new server, or the implementation of distributed services or software applications may be quite complex, with many different options to consider. As a network grows, the analysis of such options may grow exponentially, as many more options may exist.

### SUMMARY

A computer network may be modeled using a declarative definition that includes classes and relationships between classes. A discovery tool may populate a database with instances of the classes and enable an analysis tool to apply a constraint model so that a subset of possible alternatives may be defined. In some cases, further analysis may be performed on items contained in the subset.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a system for analyzing networks.

FIG. 2 is a diagram of an embodiment showing a model of a multiple server system.

FIG. 3 is a flowchart of an embodiment showing a method for discovery using a model.

### DETAILED DESCRIPTION

A model may be used to create a database of computer devices on a network. The model may be defined in a declarative manner using classes and relationships. A discoverer may crawl the network to detect devices and create instances of the classes to be stored in a database.

The model may define various classes and relationships between classes. In some cases, the classes may contain other classes as subclasses. The child classes may inherit properties from the parent class. Relationships may also be defined between various classes. The classes and relationships may be used by a discovery engine or crawler to traverse a device or network of devices to locate instances of various classes and define relationships between the instances.

A constraint model may be analyzed against a populated database to determine which instances match the constraints. The constraint model may be able to define complex configurations of hardware, software, and network interconnections and be used to identify instances where the configuration may be implemented.

The modeling and analysis mechanism may enable an efficient and very effective data collection and analysis of networks of computing devices. Crawlers that traverse a network may use the model to direct the data collection in specific directions. By using a database with a model, many poor combinations of an implementation may be quickly removed from consideration, leaving a subset of options that may be analyzed. Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

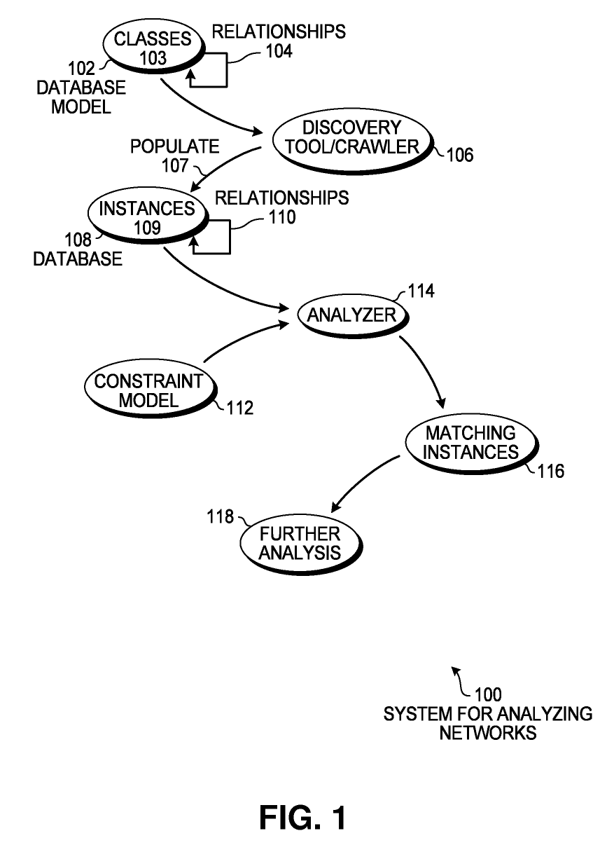

FIG. 1 is a diagram of an embodiment 100 showing a system for analyzing networks. The system uses a database that is populated by instances of classes and relationships that are consistent with a declarative model. The model may be used by a discovery tool or crawler to efficiently discover instances. Queries against the database may be made using a constraint model that defines the desired instances.

Embodiment 100 may be used as a first pass for analyzing multiple devices to find acceptable solutions to implementing changes to the information processing infrastructure. In many cases, a proposed change may have a large number of possible options and the optimization of a proposed change may take large amounts of computational time. The modeled system may be used to locate or screen potential options quickly so that further detailed analysis may evaluate options with high potential. Such a system may allow more detailed analysis to be performed in a shorter period of time.

The database model 102 contains classes 103 and relationships 104. The classes may define various elements of the computing infrastructure. Classes may be defined with child classes so that properties of a parent class may be inherited by the child class.

A class may be any trackable or detectable item in a computing infrastructure. For example, a computer class may define a computer, which may have a host of other classes connected by relationships. In the example, a computer device may have a network interface card, a processor, a certain amount of random access volatile memory, some data storage, or other hardware items.

In addition, a computer may have various related software classes. For example, a computer may have an operating system installed, several applications installed, and may provide specific services that may be used by other computers. In some embodiments, a model may define relationships between the first computer and those computers that use each service. Some classes may be distributed software applications or services that operate over multiple devices. For example, some complex email or messaging systems may have component services operating on different servers and may interact to provide a complete messaging system.

The model 102 may be used by the discovery tool/crawler 106 to populate 107 the database 108 with instances and instances of relationships 110. The discovery tool may begin by discovering a device and analyzing the device to determine properties for an instance of the device according to the model. The model may define several relationships between the class that defines the device to other classes. The discovery tool may traverse the model using the relationships to discover other instances of hardware and software components, related devices, or any other instances of classes.

The instances 109 may include instances of specific devices, such as workstations, mobile phones, personal digital assistants, servers, printers, messaging servers, directories, faxes, photocopiers, gateways, databases, web servers, web services, grid computing arrays, and other hardware devices. The instances 109 may also include instances of virtual devices or item, such as virtual applications that are operated across multiple hardware components, virtualized software components, or other devices.

The database 108 may contain instances 109 of many different classes as well as instances of relationships 110.

A constraint model 112 may be used to analyze various scenarios for implementing an upgrade or addition to the information infrastructure. In a simple example, a set of constraints may be generated for an upgrade of an operating system on a class of computer devices. The constraints may define a minimum processor speed, a minimum of free disk space, and a minimum of random access memory. When the constraints are applied to the database 108, a list of matching computer systems may be generated.

In another more complex example, a set of constraints may be defined for a distributed service that uses three server computers and several network services. The constraints may be derived from a set of best practices that are defined by the service developer. By applying the constraints to the database 108, a list of matching configurations of servers may be determined.

The analyzer 114 may match the constraint model 112 with a model defined by the instances 109 and relationships 110 taken from the real world. By matching the constraint model 112 and the real world model, a set of matching instances 116 may be defined and undergo further analysis 118.

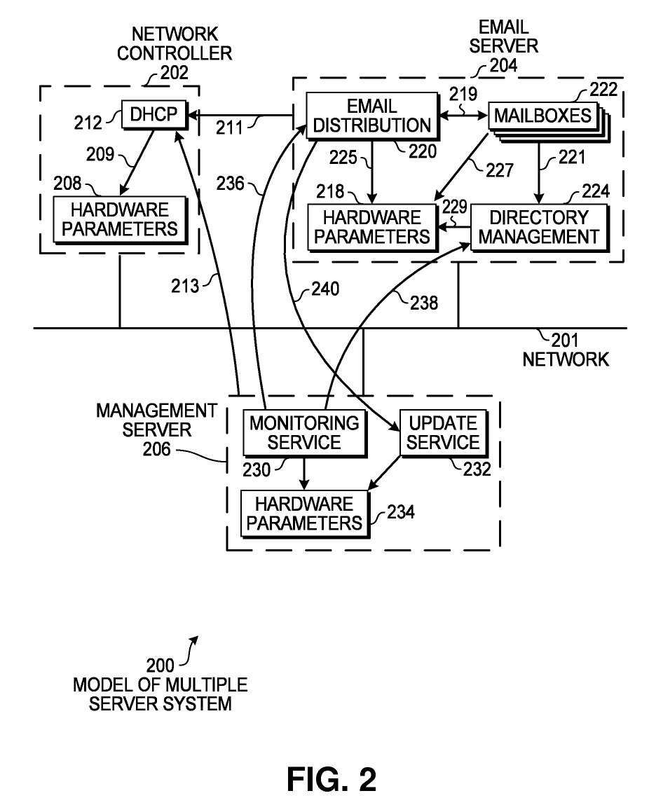

FIG. 2 is a diagram of an embodiment 200 showing a model of a multiple server system. The model illustrates a complex implementation of services that may be defined to operate on several servers. Embodiment 200 may illustrate a constraint model that may be evaluated on a database for potential implementation or a model of a typical implementation. Alternatively, embodiment 200 may illustrate an instance of a system that may be in place.

The network 201 may have a network controller 202, an email server 204, and a management server 206. Each of the server devices 202, 204, and 206 may be defined as a class and have several related classes. For example, the network controller 202 may have a DHCP service 212. The DHCP service 212 may be a separate class that is related to the network controller class. Additionally, there may be a set of hardware parameters classes 208.

In some instances, the hardware properties classes 208 may be an aggregation of the minimum hardware parameters for each of the services that are on the network controller 202. The hardware parameters classes 208 may include classes that define the memory, disk storage, processor speed, network interface capabilities, and other hardware classes.

Each service may be defined as a class and have relationships to other classes. For example, a DHCP service 212 may provide naming and other network connectivity services to other devices on a network. Such a class may have relationships to a minimum hardware configuration such as a network connection, an allotment of disk storage space, and a minimum processor performance and memory. The DHCP class 212 may thus have a relationship to the hardware parameters class 208, as indicated by the arrow 209.

The class of DHCP service 212 may have relationships to other software components, such as a particular operating system or other software components. Each of the classes to which the DHCP class is related may have additional hardware or software components. For example, the DHCP class may have a relationship to a server operating system class, which may have relationships to hardware component classes that define additional minimum hardware requirements.

Other classes may have relationships to the DHCP service 212. For example, each device attached to the network 201 may communicate with the DHCP service 212 when the device connects to the network. Thus, a relationship may be established from the other devices to the DHCP service 212, as indicated by the arrows 211 and 213.

By building relationships between various classes of devices, services, hardware components, software components, network components, and other classes, a model may be developed that can be used for many purposes, including discovery and analyzing and optimizing proposed changes.

As the various classes are defined with their respective relationships, a model may be updated easily using inherited properties between classes. For example, a change to a hardware parameter class 208 may be reflected in the DHCP service 212 because of the relationship between DHCP and the hardware parameters.

When the embodiment 200 is used as a constraint model, various minimum or optimal parameters may be defined for various classes. The parameters may be used to evaluate instances in the database for a matching set of instances. In some cases, a matching set may be determined. In other cases, a set of instances may be those instances that are closest to a set of values.

Other examples of classes may include the email server 204, which may have a set of hardware properties 218, an email distribution service 220, a set of mailboxes 222, and a directory management service 224. In the email server 204, there may be relationships defined between services. For example, the class of mailboxes 222 may have a relationship to a class of directory management service 224. The mailbox service 222 may depend on directory management service 224 being operable on the same device. Such a dependent relationship may be illustrated by arrow 221.

The class of email distribution service 220 may have a bidirectional or peer to peer relationship with the class of mailboxes 222, since the distribution service may forward email to the appropriate mailbox, as illustrated by arrow 219. However, the email distribution service 220 may or may not be constrained to operate on the same server as the mailboxes 222.

Each of the services operating on the email server 204 may have dependencies on the hardware parameters 218, as illustrated by arrows 225, 227, and 229

The management server 206 may have a monitoring service 230, an update service 232, and hardware parameters 234. The monitoring service 230 may have a dependent relationship to the email distribution service 220 and the directory management service 224, as the monitoring service 230 may provide up to date performance tracking. The dependent relationship may be illustrated with arrows 236 and 238.

Similarly, the update service 232 may have a relationship with the email distribution service 220. The update service 232 may, for example, update a spam filter on a regular basis. The dependent relationship between the email distribution service 220 and the update service 232 is illustrated by arrow 240.

For example, a relationship between multiple services, such as the various services of the email server 204 may be combined into a set of hardware parameters 218 that define a minimum set of parameters.

In some cases, relationships between multiple classes and a dependent class may be aggregated. For example, each of the services 220, 222, and 224 may each have a minimum amount of disk storage space for the application. When such services are combined on a single server, a minimum amount of disk storage space may be the sum of the requirements for each service.

In other cases, relationships between multiple classes and a dependent class may be defined differently. For example, a minimum processor speed class within the hardware parameters 218 may have a dependent relationship on the various classes of services 220, 222, and 224. In this case, the minimum processor speed may be defined to be the maximum of the three minimum parameters.

By defining a mechanism for combining a relationship, a class may have relationships added or removed without having to change the definition of the class itself. Each class may use different methodologies, calculations, and logic for combining other classes and the parameters associated with those classes.

Embodiment 200 illustrates a complex model that has multiple relationships for services that are used across a network 201. As the model is developed, each component may be defined with relationships to other components so that properties of the components may be aggregated, inherited, or otherwise combined into a cohesive model of a group of computing devices.

The model of embodiment 200 may be used to compute values for different parameters. In an example above, the amount of disk space on the email server 204 allocated to applications may be computed by summing the disk space usage of each of the services 220, 222, and 224.

The model of embodiment 200 may be traversed to inspect a group of computer devices and determine instances of each class in the model. Each relationship between device classes and service classes may be traversed to determine an instance of another device, service, relationship, or other object in the database.

Embodiment 200 also illustrates a constraint model that may be applied to a set of instances to determine if the configuration of embodiment 200 may be implemented. The set of instances in the database may be intersected with the embodiment 200 to find suitable server computers onto which the services of embodiment 200 may be installed and operated successfully.

Each model may have different level of detail and different parameters that are tracked. The level of granularity of the model may determine the type of query that may be run against a database or the type of potential configurations that may be analyzed.

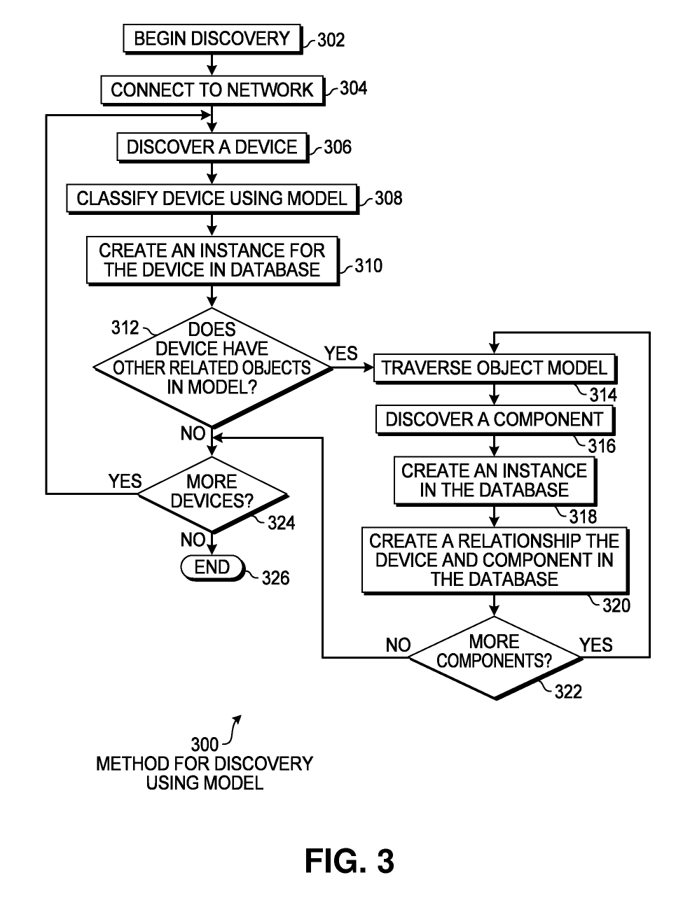

FIG. 3 is a flowchart illustration of an embodiment 300 showing a method for discovery using a model. Embodiment 300 uses the relationships and classes of a model to traverse the model and locate instances of classes and relationships to store in a database. Embodiment 300 is one mechanism that may utilize the model in determining instances of the model. Other methods may be possible using different programming techniques and logic.

The discovery operation begins in block 302. A device performing the discovery routine may connect to a network in block 304 and discover a device 306.

A device may be discovered in any manner in block 306. In some cases, broadcast network messages, DHCP queries, DNS queries, or other network messages may be used to locate one or more devices to discover.

After a device is discovered in block 306, the device may be classified in block 308 as an instance of a class in the model and stored in the database in block 310. Various queries or techniques may be used to determine to which class or classes the device may belong. Such queries may be automated queries that probe various locations within the operating system or other area to determine the type of device.

If other related objects may be attached to the device, according to the relationships defined in the model in block 312, the object model is traversed in block 314 to discover a component or other class in block 316. An instance of the class may be created in block 318, as well as an instance of the relationship in block 320. If additional components or related classes exist in block 322, the process returns to block 314. If not, the process continues to block 324.

If more devices are present in block 324, the process returns to block 306 to discover another device. Otherwise, the process ends in block 326.

Embodiment 300 is a simplified version of a method for traversing the model and its relationships to locate, classify, and create instances of classes that model hardware and software components in a network environment. By traversing the web of relationships, many objects within a system may be quickly identified and classified.

Once a device is classified in block 308, each object to which it may have a relationship may be searched and, if found, an instance created. When performing a search for a particular object, the searching algorithm may be searching for a specific component, which may be more efficient than searching for any component and attempting to discern what type a component it may be once it is found. Further, searching may be limited to searching for particular instances of objects to which a relationship is suspected.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
defining a database model having class definitions and relationship definitions, said relationship definitions comprising relationships between at least two of said classes, said database model defining computing devices attached to a network;
populating said database with instances of said computing devices; and
analyzing said database by defining a constraint model, applying said constraint model to said database, and determining a subset of matching instances.

2. The method of claim 1, said classes comprising software items.

3. The method of claim 2, said software items comprising services.

4. The method of claim 2, said software items comprising applications installed on one of said computing devices.

5. The method of claim 1, a first of said classes being a subset of a second of said classes, said second of said classes having a set of properties, said set of properties being applied to said first set of classes through inheritance.

6. The method of claim 1, said analyzing further comprising a detailed analysis on each member of said subset of matching instances.

7. The method of claim 1, said populating said database being performed by crawling a network, discovering a device, and analyzing said device to determine said instances.

8. The method of claim 1, said constraint model defining a set of requirements for a proposed change to at least one of said computing devices.

9. A computer readable medium comprising computer executable instructions adapted to perform the method of claim 1.

10. A system comprising:
a database comprising instances of a database model, said instances comprising data from a plurality of computing devices attached to a network, said database having a database model comprising class definitions and relationship definitions, said relationship definitions comprising relationships between at least two of said classes;
a crawler adapted to traverse said network, detect said computing devices, and populate said database with said instances;
an analyzer adapted to apply a constraint model against said database to determine a subset of matching instances.

11. The system of claim 10, said classes comprising software items.

12. The system of claim 11, said software items comprising services operating on said computing devices.

13. The system of claim 11, said software items comprising applications installed on said computing devices.

14. The system of claim 10, at least one of said classes being related by inheritance to a second of said classes.

15. A method comprising:
populating a database, said database being defined by a database model having classes and relationships, said populating comprising:
traversing a network;
detecting a device attached to said network;
analyzing said device to determine instances of said classes and relationships; and
storing said instances in said database; and
analyzing said database by defining a constraint model, applying said constraint model to said database, and determining a subset of matching instances.

16. The method of claim 15, said classes comprising software items.

17. The method of claim 16, said software items comprising services.

18. The method of claim 16, said software items comprising applications installed on said device.

19. The method of claim 15, at least one of said classes being related by inheritance to a second of said classes.

20. A computer readable medium comprising computer executable instructions adapted to perform the method of claim 15.
